(19) United States
(12) Patent Application Publication
(10) Pub. No.: US 2005/0232174 A1
(43) Pub. Date: Oct. 20, 2005

(54) Linear interference cancellation receiver for edge systems

(75) Inventors: Eko N. Onggosanusi, Allen, TX (US); Timothy M. Schmidl, Dallas, TX (US); Anand G. Dabak, Plano, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/108,412

(22) Filed: Apr. 18, 2005

Related U.S. Application Data
(60) Provisional application No. 60/563,742, filed on Apr. 19, 2004.

(51) Int. Cl. H04B 3/20

(52) U.S. Cl. 370/286

(57) ABSTRACT

A method for providing interference suppression in a communication device includes receiving a signal, determining if the received signal comprises a Gaussian Minimum Shift Keying (GMSK) or an 8 phase shift keying (8PSK) signal. Over sampling and inphase and quadrature phase separation with real-valued signal processing on the received signal is performed whenever the received signal is determined to be a GMSK signal. Oversampling with complex-valued signal processing on the received signal is performed whenever the received signal is determined to be an 8PSK signal. A receiver is also disclosed that provides for interference suppression.

### CROSS-REFERENCE TO RELATED APPLICATIONS

This application claims priority to U.S. Provisional Application No. 60/563,742 filed Apr. 19, 2004, and entitled “Linear Single Antenna Interference Cancellation Receiver for Edge Systems,” by Eko N. Onggosanusi et al, incorporated herein by reference.

### FIELD OF THE INVENTION

This invention relates in general to the field of communications and more specifically to antenna interference cancellation.

### BACKGROUND OF THE INVENTION

Single-antenna interference cancellation (SAIC) has been become popular in Global System for Mobile communication (GSM) standardization efforts due to its potential in providing significant capacity increase for high frequency reuse GSM networks. In the United States, a frequency reuse factor of one-to-one is typically used in GSM networks. Such GSM networks can be severely limited by co-channel interference (CCI) issues. Compared to GSM systems, Enhanced Data rates for GSM Evolution (EDGE) systems employ 8 Phase Shift Keying (8PSK) modulation in addition to Gaussian Minimum Shift Keying (GMSK) modulation. Therefore, the SAIC algorithm must be adapted in response to the change in the data modulation of the desired user, as well as that of the dominant interferer for some algorithms.

One non-linear multi-user SAIC scheme for EDGE is the use of joint detection. However, this approach is highly complex even after employing reduced state sequence estimation (RSSE) techniques. Hence, it is hard to incorporate this technique in any current state-of-the-art digital signal processor (DSP). Other schemes such as successive/serial interference cancellation do not work well with 8PSK signals, since the 8PSK tentative decisions tend to be unreliable. Another drawback of any multi-user SAIC scheme for EDGE is that it requires detection of the dominant interferer, which is more complex and sensitive for systems that employ more than one modulation scheme such as EDGE systems. Given this, a need exists in the art for a system and method that can provide for interference cancellation of a signal such as an 8PSK signal for EDGE systems.

### BRIEF DESCRIPTION OF THE DRAWINGS

The features of the present invention, which are believed to be novel, are set forth with particularity in the appended claims. The invention may best be understood by reference to the following description, taken in conjunction with the accompanying drawings, in the several figures of which like reference numerals identify like elements, and in which:

FIG. 1 shows a SAIC receiver in accordance with an embodiment of the invention;

FIG. 2 shows a graph highlighting the results of one co-channel interferer, GMSK signal in accordance with one embodiment of the invention;

FIG. 3 shows a graph highlighting the results of one co-channel interferer, 8PSK signal in accordance with one embodiment of the invention;

FIG. 4 shows a graph highlighting one co-channel interferer, GMSK signal using another configuration in accordance with an embodiment of the invention; and

FIG. 5 shows a graph highlighting one co-channel interferer, 8PSK signal using another configuration in accordance with an embodiment of the invention.

### DETAILED DESCRIPTION OF THE PREFERRED EMBODIMENTS

In accordance with an embodiment of the invention, a low-complexity linear blind capable SAIC receiver algorithm and receiver for EDGE systems is disclosed that provides significant amount of gain in different conditions. In one embodiment, a single antenna is used at the receiver with “virtual antennas” being provided for interference suppression. The “virtual antennas” are provided for GMSK signals by exploiting the spectral redundancy property of GMSK-modulated signals for Inphase and Quadrature signals. This redundancy can not be exploited for 8PSK signals since the 8PSK signal is complex with the Inphase and Quadrature signals carrying different information. For 8PSK signals as well as for GMSK signals, oversampling is used. Oversampling is beneficial for an interference suppression receiver since the additional degrees of freedom contain some new information on the interference. In still another embodiment, Q-times oversampling is performed using baud rate sampling followed by a Q-times interpolator. In other embodiments, one can choose not to oversample, in this case Q=1.

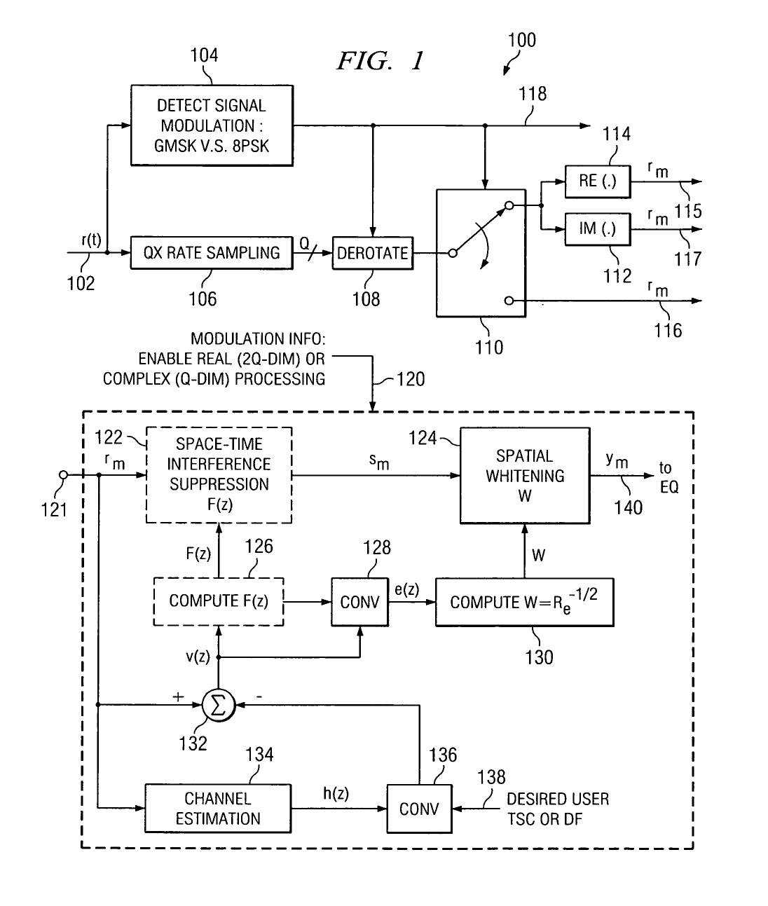

Referring now to FIG. 1, there is shown a receiver 100 in accordance with one embodiment of the invention. A received signal r(t) is received at input 102, and a modulation detector 104 is used to determine whether the signal is GMSK or 8PSK modulated. The modulation detector 104 can be designed in a number of ways. In an illustrative example the modulation detector 104 performs a post channel estimation squared error within the signal's mid-amble. The receiver performs two channel estimations, one for the case where the desired signal is a GMSK signal and one for the case where the desired signal is an 8PSK signal. The receiver can then regenerate the midamble for the GMSK case using the channel estimates and the training sequence code (TSC) for GMSK and find the squared error between the midamble samples and the regenerated midamble. This is an estimate of the noise+interference power. Similarly, the receiver can regenerate the midamble for the 8PSK case and find the squared error. The hypothesis with the lower squared error (GMSK or 8PSK) is chosen by the modulation detector. In order to improve the accuracy of the modulation detector, a filtering operation can be used on the squared errors from multiple midambles. For example, the squared errors can be averaged over a frame before making the modulation decision. In parallel to the modulation detector is found a Q-times rate sampler 106 that samples the signal 102 at a Q-times rate. The sampled signal is provided to a derotation (de-rotation) circuit 108 which de-rotates the sampled signal differently for GMSK and 8PSK signals. Extraction of the Inphase (real) 114 and Quadrature (imaginary components 112, is performed only for GMSK signals via the top path of switch 110 which is under the control of the detector 104. The bottom path allows 8PSK signals to flow through. The detector 104 after detecting the type of modulation (GMSK or 8PSK) sends the appropriate control signal to switch 110. For the top path for GMSK signals, rₘ is the vector signal representing the real 2Q dimensional samples. There is a factor of 2 because there are both Inphase and Quadrature samples. For the bottom path for 8PSK signals, rₘ is the vector signal representing the complex Q dimensional samples. It should be noted that extracting Inphase and Quadrature components can also be performed for 8PSK. However, it may not be beneficial since the underlying data modulation (8PSK) is complex-valued.

The appropriate vector signal (rₘ) 115, 116, 117 is provided to an optional space-time interference suppression circuit 122 which performs interference suppression and provides a suppressed signal (Sₘ) to a spatial whitening circuit 124. The vector signal (rₘ) is also sent to a channel estimation circuit 134 in order to determine a channel estimate h(z). The channel estimate is then converted in block 136 using a predetermined training sequence code (TSC) or decision feedback (DF) provided at 138. A summation circuit provides as an output an estimate of the interference component v(z) which is sent to the first stage filter computation block 126 where the first stage F(z) of the filter is determined. Block 128 then calculates the residual interference component e(z). The residual interference component e(z) is then used by block 130 which determines a spatial whitener W which is used by the spatial whitening circuit 124. The space-time interference suppression and spatial whitening circuit block 150 receives the required modulation information to enable the proper real (2Q-dimensional) or complex (Q-dimensional) processing via line 120. More details of the receiver and its operation are provided below.

A GMSK-modulated signal allows the following linear approximation:

$$x ( t ) = {\sum }_{p = - ∞}^{∞} {j}^{p + 1} {a}_{p} {C}_{0} ( t - pT ) , {a}_{p} ∈ \{ \pm 1 \} \qquad ( 1 )$$

where T is one symbol in duration and C₀(t) is the GMSK waveform of duration 4 T. Likewise, the 8PSK modulation per the EDGE standard employs the C₀(t) waveform for partial response signaling. The 8PSK-modulated signal has the following form:

$$\begin{matrix}x ( t ) = {\sum }_{p = - ∞}^{∞} {ⅇ}^{3 π ( p + 1 ) / 8} {a}_{p} {C}_{0} ( t - pT ) \cdot {a}_{p} \\ = {ⅇ}^{j2πⅈ / 8} , i ∈ \{ 0 , 1 , … , 7 \}\end{matrix} \qquad ( 2 )$$

The baseband received signal can be written as:

$$\tilde{r} ( t ) = {\sum }_{p = - ∞}^{∞} {ⅇ}^{ϕ ( p + 1 ) {a}_{p} \tilde{h} ( t - pT ) + \tilde{v} ( t )}$$

where \tilde{h}(t)is the overall channel impulse response including C₀(t) with delay spread of LT, ñ(t)is the thermal noise, \tilde{v}(t) is the total interference plus noise, and φ=π/2 for GMSK and 3π/8 for 8PSK. The continuous time received signal is then sampled at Q times the baud rate. Defining \tilde{r}ₘ yields:

$${\tilde{r}}_{m} = [ \begin{matrix}{\tilde{r}}_{Qm} \\ {\tilde{r}}_{Qm + 1} \\ ⋮ \\ {\tilde{r}}_{Qm + ( Q - 1 )}\end{matrix} ] , where {\tilde{r}}_{Qm + q} = \tilde{r} ( \frac{( Qm + q ) T}{Q} ) \qquad ( 3 )$$

Then it can be shown that:

$$\begin{matrix}{\tilde{r}}_{m} = {\sum }_{p = - ∞}^{∞} {ⅇ}^{ϕ ( p + 1 )} {a}_{p} [ \begin{matrix}\tilde{h} ( ( m - p ) T ) \\ {\tilde{h}}^{( 1 )} ( ( m - p ) T + \frac{T}{Q} ) \\ ⋮ \\ {\tilde{h}}^{( 1 )} ( ( m - p ) T + \frac{Q - 1}{Q} T )\end{matrix} ] + {\tilde{v}}_{m} \\ = {\sum }_{p = - ∞}^{∞} {ⅇ}^{ϕ ( p + 1 )} {a}_{p} {\tilde{h}}_{m - p} + {\tilde{v}}_{m} \\ = {ⅇ}^{ϕ ( m + 1 )} {\sum }_{l = 0}^{L} ( {ⅇ}^{- ϕ l} {\tilde{h}}_{l} ) {a}_{m - l} + {\tilde{v}}_{m}\end{matrix}$$

This shows that Q-times oversampling provides an additional (Q−1) degrees of freedom, acting as a set of virtual correlated antennas.

When a GMSK signal is detected by modulation detector 104, derotation by φ=π/2 and Inphase-Quadrature component extraction is performed by 112, 114 in FIG. 1 and results in the following:

$$\begin{matrix}[ \begin{matrix}Re ( {j}^{- ( m + 1 )} {\tilde{r}}_{m} ) \\ Im ( {j}^{- ( m + 1 )} {\tilde{r}}_{m} )\end{matrix} ] = {\sum }_{l = 0}^{L} [ \begin{matrix}Re ( {j}^{- 1} {\tilde{h}}_{l}^{( 1 )} ) \\ Im ( {j}^{- 1} {\tilde{h}}_{l}^{( 1 )} )\end{matrix} ] {a}_{m - l}^{( 1 )} + \\ [ \begin{matrix}Re ( {j}^{- ( m + 1 )} {\tilde{v}}_{m} ) \\ Im ( {j}^{- ( m + 1 )} {\tilde{v}}_{m} )\end{matrix} ] ⇔ {r}_{m} \\ = {\sum }_{l = 0}^{L} {h}_{l} {a}_{m - l} + {v}_{m} ∈ {R}^{2 Q}\end{matrix} \qquad ( 4 )$$

This results in a single-input 2Q-output real-valued channel. Essentially, spectral redundancy from the fact that aₖ is a real-valued symbol is exploited.

When an 8PSK signal is detected by the modulation detector 104, derotation by φ=3π/8 results in the following:

$$\begin{matrix}{r}_{m} = {ⅇ}^{- 3 π ( m + 1 ) / 8} {\tilde{r}}_{m} \\ = {\sum }_{l = 0}^{L} ( {ⅇ}^{- 3 π l / 8} {\tilde{h}}_{l} ) {a}_{m - l} + {ⅇ}^{- 3 π ( m + 1 ) / 8} {\tilde{v}}_{m} \\ = {\sum }_{l = 0}^{L} {h}_{l} {a}_{m - l} + {v}_{m} ∈ {C}^{Q}\end{matrix} \qquad ( 5 )$$

which gives a single-input Q-output complex-valued channel.

The oversampled received vector signal rₘ is then processed by a space-time interference suppression matrix filter as follows:

$$\begin{matrix}{y}_{m} = {\sum }_{n = 0}^{N} {G}_{n} {r}_{m - n} \\ = {G}_{0} {r}_{m} + {\sum }_{n = 1}^{N} {G}_{n} {r}_{m - n}\end{matrix} \qquad ( 6 )$$

where Gₙ (εR^{2Q2Q} for GMSK and εC^{QxQ} for 8PSK) is the n-th tap of the matrix filter. In the z-domain, y(z)=G(z)r(z)=G(z)(h(z)α(z)+v(z)). The processed 2Q-vector signal yₘ 140 serves as the input of the desired user equalizer such as a MLSE, DFE or other type of equalizer. The effective ISI channel for the equalizer is now equal to h_{eq}(z)=G(z)h(z).

The above proposed algorithm is not limited to co-channel interference suppression. The algorithm can also suppress adjacent channel interference. The algorithm can also be extended to the case of multiple antennas at the receiver. With P>1 antennas at the receiver, the received signal vectors are stacked from the P receive antennas into one vector with P times the length. This results in a 2PQ-dimensional real-valued rₘ in equation (4) for GMSK, which is associated with a single-input 2PQ-output real-valued channel. For 8PSK, this results in PQ-dimensional complex-valued rₘ in equation (5) for 8PSK, which is associated with single-input PQ-output complex-valued channel. The design technique is the same as that for single-antenna receiver (P=1). The difference is simply in dimensionality as a result of having additional receive antennas.

Receiver Filter Design

In one embodiment a space-time matrix filer

$$G ( z ) = {G}_{0} + {\sum }_{n = 1}^{N} {G}_{n} {z}^{- n}$$

is decomposed into two parts as follows:

$$G ( z ) = WF ( z ) , where \\ W = {G}_{0} , F ( z ) = I + {\sum }_{n = 1}^{N} {F}_{n} {z}^{- n} \qquad ( 7 )$$

The filter design in accordance with one embodiment is designed with the following criteria:
(1) The first stage F(z) 122 is designed to suppress the total interference component v(z) without affecting the desired signal component h(z), hence, the first tap in F(z) is I.
(2) The second stage W is chosen to spatially whiten the residual interference component after space-time interference suppression has been performed.

The first stage is optional, since N can be set to 0. Setting N=0 results in better performance in some scenarios. F(z) increases the effective channel constraint length before equalization by N. The spatial whitener W 124, does not affect the effective channel memory.

It can be assumed that only the channel estimate of the desired user is available via some kind of channel estimation algorithm, for example, using a single-user correlator, a single-user least square technique or a joint least square technique. The algorithm is said to be blind to the interference parameters. Given the received signal r(z) and the desired user channel estimate \tilde{h}(z), the interference component v(z) can be estimated as follows:
v(z)=r(z)−ĥ(z)\hat{α}(z) (8)
where \hat{α}(z) is an estimate of the desired user data. This can be obtained as follows:
V(z) can be estimated only within the mid-amble of each burst. In this case, \hat{α}(z) is the desired user TSC which is completely known.
If additional data is desired, a decision-directed approach can be used. A preliminary data estimate either using a hard or soft estimate can be obtained using the output of a matched filer or even the interference suppression filter. The estimate is then used in conjunction with the desired user TSC in order to obtain a longer estimate v(z). In an alternate embodiment, a per-survivor processing (PSP) technique can be used to obtain more accurate preliminary data estimates at the expense of complexity.

The interference estimate v(z) is then used to compute F(z) in block 126 according to an optimization criterion such as:

$${min}_{{F}_{1} … {F}_{N}} {\sum }_{m ∈ B} {‖ {v}_{m} + {\sum }_{n = 1}^{N} {F}_{n} {v}_{m - n} ‖}^{2} = {min}_{{F}_{1} … {F}_{N}} {\sum }_{m ∈ B} {‖ {e}_{m} ‖}^{2} \qquad ( 9 )$$

where e(z)=F(z)v(z) is the residual interference after interference suppression and B is the index set depending on where v(z) is computed within a burst. The optimization problem in equation (9) can be viewed as a linear prediction problem. The solution can be obtained using any adaptive filtering algorithm or analytically as follows:

$$\begin{matrix}Letting B = \{ N , N + 1 , … , M \} \\ v = [ \begin{matrix}\begin{matrix}\begin{matrix}{v}_{N} \\ {v}_{N + 1}\end{matrix} \\ ⋮\end{matrix} \\ {v}_{M}\end{matrix} ] , f = vec ( [ {F}_{1} {F}_{2} … {F}_{N} ] ) \\ A = [ \begin{matrix}{e}_{N - 1}^{T} & {e}_{N - 2}^{T} & ⋯ & {e}_{0}^{T} \\ {e}_{N}^{T} & {e}_{N - 1}^{T} & ⋯ & {e}_{1}^{T} \\ ⋮ & ⋮ & ⋰ & ⋮ \\ {e}_{M - 1}^{T} & {e}_{M - 2}^{T} & ⋯ & {e}_{M - N}^{T}\end{matrix} ] ⊗ I\end{matrix}$$

Then, the solution to equation (9) is given as:

$${f}_{opt} = \begin{matrix}min \\ f\end{matrix} {‖ v - A f ‖}^{2} = {( {A}^{H} A )}^{- 1} {A}^{H} v \qquad ( 10 )$$

From fₒₚₜ;

$${F}_{opt} ( z ) = I + {\sum }_{n = 1}^{N} {F}_{n , opt} {Z}^{- n}$$

can be obtained.

The spatial whitening transformation W can be obtained from the residual interference estimate e(z)=Fₒₚₜ(z)\hat{v}(z). First, an estimate of the spatial covariance matrix is obtained as follows:

$${R}_{e} = \frac{1}{\vert B \vert} {\sum }_{m ∈ B} {e}_{m} {e}_{m}^{T} \qquad ( 11 )$$

which is then used for deriving the spatial whitening transformation:
W=Rₑ^{-1/2} (12)
It should be noted that when N=0, e(z)=v(z). For asynchronous systems where the interference may be present only within a part of a burst, some decision-directed algorithm can be used to adapt the matrix filter G(z) to changes in the interference structure. The algorithm can start from the mid-amble since the desired user training sequence code (TSC) is known and then adapt from the center to the beginning and end of each burst. In this case, an efficient algorithm to update matrix inverses can also be used. The decision-directed adaptive algorithm can be based on a host of standard adaptive filtering algorithms such as NLMS and RLS (Kalman filtering).

Taking the square-root of a matrix is needed to compute the spatial whitening transformation (see equation 12). This may increase the receiver complexity significantly since it involves computing a symmetric matrix factorization. However, when an equalizer that uses a matched filtering as a front-end is used, the square-root operation can be circumvented. In this case, the equalizer requires only the channel correlation estimates. The channel correlation polynomial is given as:
p(z)=||WF(z)h(z)||²=h(z)^{r} F(z)^{T} Rₑ⁻¹ F(z)h(z) (13)
which does not require computing the square-root of Rₑ⁻¹. Such simplification can also be done for MLSE equalizer when a front-end matched filter is used. In this case, the branch metric definition needs to be modified to take into account the noise correlation after matched filtering. The effective channel for the equalizer is the channel correlation polynomial in equation (13).

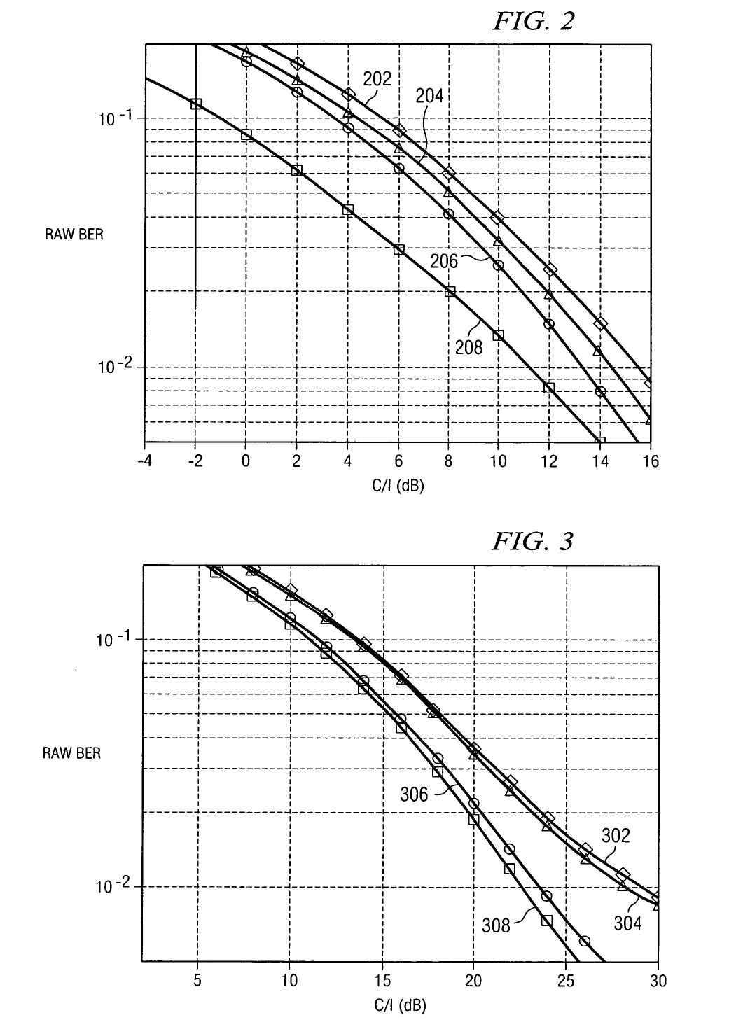

Referring to FIGS. 2 and 3, link level simulation results are provided. The following scenario is considered in the simulations:
Fully synchronous network with 1 co-channel interferer with C/N=30 dB and configuration 3 of GERAN with 40% loading, with 3 dominant interferers, with random TSC assignments for the interferers.
TU-3 channel, GMSK and 8PSK modulation.
   A conventional Maximum Likelihood Sequence Estimator (MLSE) receiver and the SAIC receiver of the present invention are compared with N=0 (spatial whitening only, denoted as SPWH) with OF=2. For the proposed SAIC receiver, TSC-based training is used to obtain interference estimates.

In FIG. 2, the performance with one co-channel interferer and a GMSK signal is simulated for raw Bit Error Rate (BER) versus Carrier/Interference in dB. Graph line 202 corresponds to an 8PSK interferer and using a conventional receiver technique. Graph line 204 is for a GMSK interferer and using a conventional receiver technique. Graph line 206 is for an 8PSK interferer and using spatial whitening, while graph line 208 highlights the simulation results for a GMSK interferer and using spatial whitening. In FIG. 3 there are shown simulation results for an 8PSK signal, with graph line 302 reflecting a GMSK interferer and using a conventional receiver. Graph line 304 highlights the results for an 8PSK interferer and using a conventional receiver technique. Graph line 306 highlights the results for an 8PSK interferer and spatial whitening, and finally graph line 308 highlights a GMSK interferer and using spatial whitening.

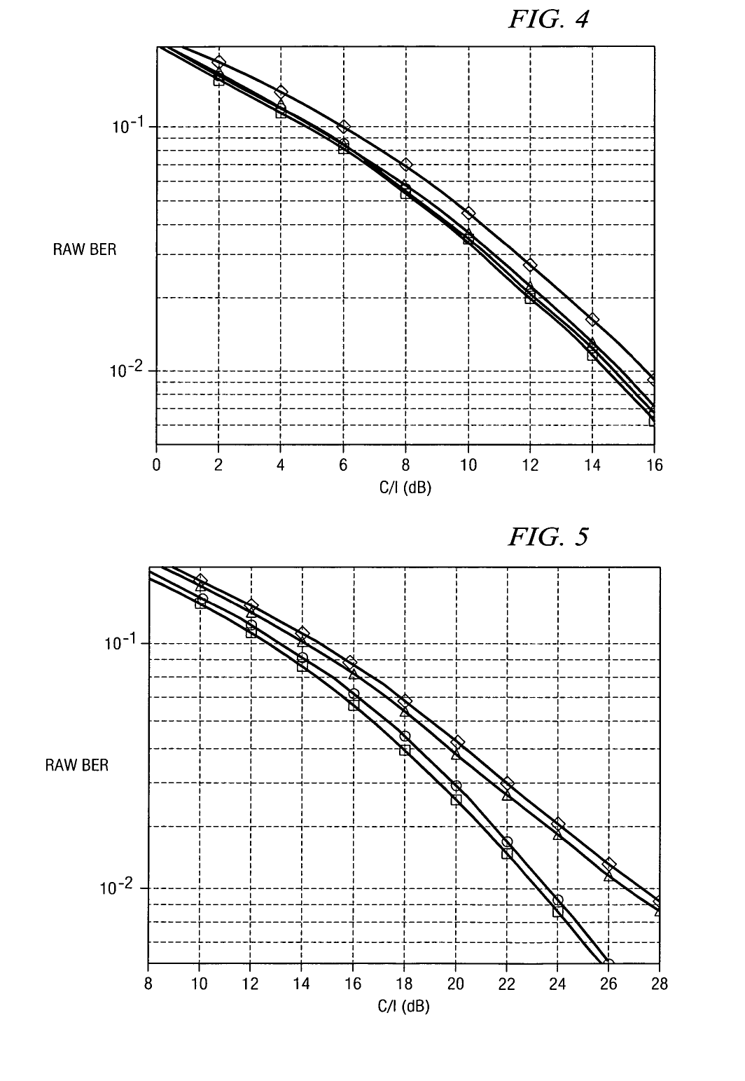

The Configuration 3 results are given in FIGS. 4 and 5. FIG. 4 shows the simulation results for 1 co-channel interferer with a GMSK signal. Graph line 402 highlights the results for an 8PSK interferer and using a conventional receiver. Graph line 404 highlights the results for a GMSK interferer and using a conventional receiver. Graph line 406 highlights a GMSK interferer and using spatial whitening. Finally, graph line 408 highlights an 8PSK interferer and using spatial whitening. In FIG. 5, there are shown the results for Configuration 3 using an 8PSK signal. Graph line 502 highlights the results for a GMSK interferer and using a conventional receiver. Graph line 504 highlights an 8PSK interferer and using a conventional receiver. Graph line 506 highlights an 8PSK interferer and using the invention's spatial whitening technique. Finally, graph line 508 highlights a GMSK interferer and using spatial whitening. The simulations highlight the significant gain offered by the proposed SAIC receiver under any of the scenarios that have been simulated.

The above discussion is meant to be illustrative of the principles and various embodiments of the present invention. Numerous variations and modifications will become apparent to those skilled in the art. It is intended that the following claims be interpreted to embrace all such variations and modifications.

1. A method for providing interference suppression in a communication device, comprising:
receiving a signal with P receive antenna(s);
determining if the received signal comprises a Gaussian Minimum Shift Keying (GMSK) or a 8 phase shift keying (8PSK) signal;
performing Q-times oversampling where Q is a positive integer and inphase and quadrature phase separation with real-valued signal processing on the received signal whenever the received signal is determined to be a GMSK signal; and
performing Q-times oversampling where Q is a positive integer with complex-valued signal processing on the received signal whenever the received signal is determined to be a 8PSK signal.

2. A method as defined in claim 1, where the number of receive antennas P is 1.

3. A method as defined in claim 1 where the number of receive antennas P is 2.

4. A method as defined in claim 1 where the oversampling rate Q is 2.

5. A method as defined in claim 1, wherein the inference suppression is performed for an EDGE system.

6. A method as defined in claim 1, further comprising:
performing space time interference suppression on the received signal.

7. A method as defined in claim 1, further comprising:
switching between the real-valued and complex-valued processing of the received signal based on if the received signal is determined to be a GMSK or 8PSK signal.

8. A method as defined in claim 1, further comprising:
performing spatial whitening on the received signal.

9. A method as defined in claim 8, further comprising:
performing space-time interference suppression on the received signal

10. A method as defined in claim 8, further comprising:
using a residual interference component to determine a spatial whitening transformation to be used to perform the spatial whitening.

11. A method as defined in claim 1, further comprising:
switching between extracting Inphase and Quadrature phase signals if the received signal is determined to be a GMSK signal and not performing Inphase and Quadrature phase extraction if the signal is determined to be a 8PSK signal.

12. A method as defined in claim 1, further comprising:
using a training sequence code to arrive at a spatial whitening transformation to be performed on the received signal to yield a 2Q-vector signal for use by an equalizer.

13. A method as defined in claim 1, further comprising:
performing spatial whitening on the received signal using a spatial whitening matrix; and
using a decision-directed adaptive algorithm to update the spatial whitening matrix.

14. A method as defined in claim 1, further comprising:
performing spatial whitening on the received signal using a spatial whitening matrix; and
using decision feedback training in order to obtain the spatial whitening matrix.

15. A method as defined in claim 1, further comprising:
performing space-time interference suppression on the received signal, the space-time interference suppression being performed with a space-time interference matrix; and
using a decision feedback training to update the space-time interference matrix.

16. A method as defined in claim 1, further comprising:
performing space-time interference suppression on the received signal, the space-time interference suppression being performed with a space-time interference matrix; and
using a decision-directed adaptive filtering algorithm to obtain the space-time interference matrix.

17. A method as defined in claim 1, further comprising:
performing spatial whitening on the received signal using a spatial whitening matrix; and
using a decision-directed adaptive filtering algorithm to obtain the spatial whitening matrix.

18. A receiver that performs interference cancellation, comprising:
signal modulation detector for determining if a received signal is a Gaussian Minimum Shift Keying (GMSK) or a 8 phase shift keying (8PSK) signal;
an Q-times oversampler for performing Q-times oversampling on the received signal in order to provide a Q-times oversampled signal where Q is a positive integer; and
switch circuit for causing GMSK signal to be inphase and quadrature phase separated and real-valued processed if the signal is determined to be a GMSK signal by the signal modulation detector, and performing complex-valued processing on the received signal if the signal is determined to be a 8PSK signal.

19. A receiver as defined in claim 18, wherein the receiver comprises an EDGE receiver.

20. A receiver as defined in claim 18, further comprising:
a space-time interference suppressor having a space-time matrix.

21. A receiver as defined in claim 18, further comprising:
a spatial whitener having a spatial whitening matrix.

22. A receiver as defined in claim 18, further comprising:
a space-time interference suppressor having a space-time matrix that is found using a midamble of the received signal.

23. A receiver as defined in claim 18, further comprising:
a spatial whitener having a spatial whitening matrix that is found using a midamble of the received signal.

24. A receiver as defmed in claim 18, further comprising:
a switch for switching between extracting Inphase and Quadrature phase signals if the received signal is determined to be a GMSK signal and not performing Inphase and Quadrature phase extraction if the signal is determined to be a 8PSK signal.
